(19) United States
(12) Patent Application Publication
(10) Pub. No.: US 2024/0123862 A1
(43) Pub. Date: Apr. 18, 2024

(54) METHODS AND SYSTEM FOR PREPARING A VEHICLE FOR EXTENDED STORAGE

(71) Applicant: Ford Global Technologies, LLC, Dearborn, MI (US)

(72) Inventors: Patrick Soderborg, Dexter, MI (US); Gitanjli McRoy, Ann Arbor, MI (US); Shannon Wrobel, Ann Arbor, MI (US); Andrew Mast, Northville, MI (US)

(21) Appl. No.: 18/047,218

(22) Filed: Oct. 17, 2022

(51) Int. Cl. B60L 58/12; B60L 53/60; B60R 16/033; H02J 7/00

(52) U.S. Cl. CPC B60L 58/12; B60L 53/60; B60R 16/033; H02J 7/00032; H02J 7/007

(57) ABSTRACT

Systems and methods for operating a vehicle that includes an electric power source for providing propulsive effort to the vehicle are is described. In one example, a remote or external device may generate a request to prepare a vehicle for extended or long term storage. A state of charge of a traction battery and a state of charge of a low voltage battery may be adjusted to prepare the vehicle for extended storage.

### FIELD

The present description relates to methods and a system for operating a vehicle that includes an electric power source for providing propulsive effort to the vehicle.

### BACKGROUND AND SUMMARY

Electric vehicles and hybrid vehicles may include a battery for supplying charge to an electric machine. The electric machine may supply torque to propel the vehicle. While some vehicles may be operated frequently, daily or weekly for example, other vehicles may be operated only during conditions which may be deemed desirable by the vehicle's user. For example, recreational vehicles may be used during summer months and they may be stored during winter months. If a vehicle is stored for an extended period of time (e.g., not operated for more than a period of three weeks), the life span and charge capacity of the traction battery may be degraded. Therefore, it may be desirable to provide a way of storing a vehicle that may reduce a possibility of traction battery degradation.

The inventors herein have recognized the above-mentioned issues and have developed a method for preparing a vehicle for storage, comprising: via a controller, preparing a traction battery for extended storage via a first procedure when the vehicle is not electrically coupled to a charging source; and via the controller, preparing the traction battery for extended storage via a second procedure when the vehicle is electrically coupled to the charging source.

By tailoring procedures for preparing a traction battery for extended storage, it may be possible to reduce a possibility of traction battery degradation whether the traction battery is stored while connected to a stationary electric grid or while the traction battery is not connected to the stationary electric grid. For example, a user of a vehicle may be prompted to discharge the traction battery so that the traction battery is stored under conditions where traction battery degradation may be expected to be reduced. Conversely, if the vehicle is going to be coupled to the electric grid while the vehicle is stored for an extended duration, the traction battery may supply electric power to the stationary electric grid or receive electric power from the stationary electric grid so that the traction battery may be stored within a desired or requested range of charge (e.g., between 20% and 50% of the traction battery's charge storage capacity). Storing the traction battery with an amount of charge that is within a requested charge range, may reduce traction battery degradation and help to maintain traction battery charge capacity.

The present description may provide several advantages. In particular, the approach may reduce traction battery and low voltage battery degradation. Further, the approach may notify a user of when and how to store a vehicle to reduce a possibility of battery degradation. In addition, the approach provides vehicle storage solutions for on-plug (e.g., the vehicle is electrically coupled to a stationary electric power grid) and off-plug (e.g., the vehicle is not electrically coupled to a stationary electric power grid) vehicle storage.

The above advantages and other advantages, and features of the present description will be readily apparent from the following Detailed Description when taken alone or in connection with the accompanying drawings.

The summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of an electric vehicle driveline;

FIG. 2 is an example operating sequence according to the present method;

FIGS. 3-9 show flowcharts of a method for preparing a vehicle for extended or long term storage; and

FIG. 10 shows example travel routes for a vehicle.

### DETAILED DESCRIPTION

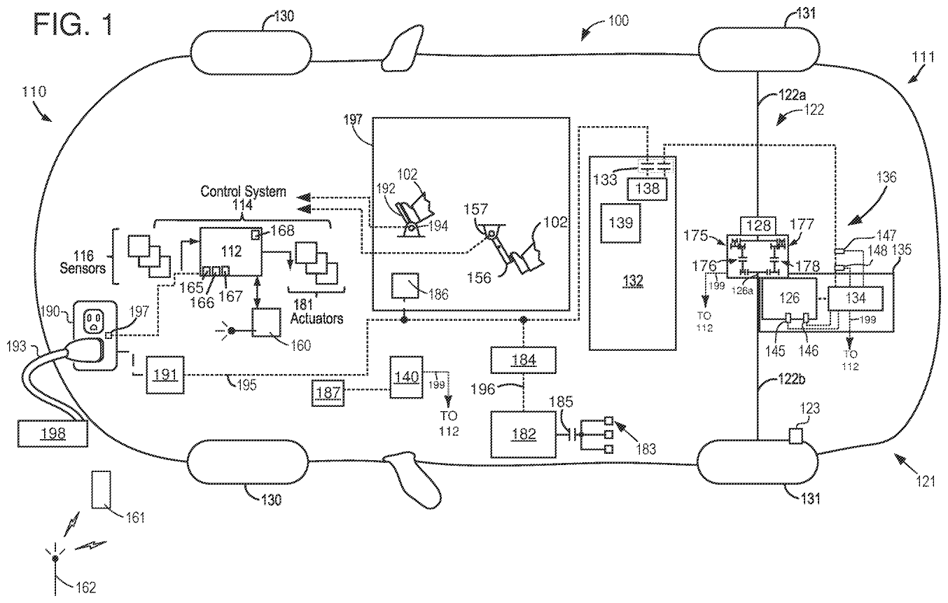

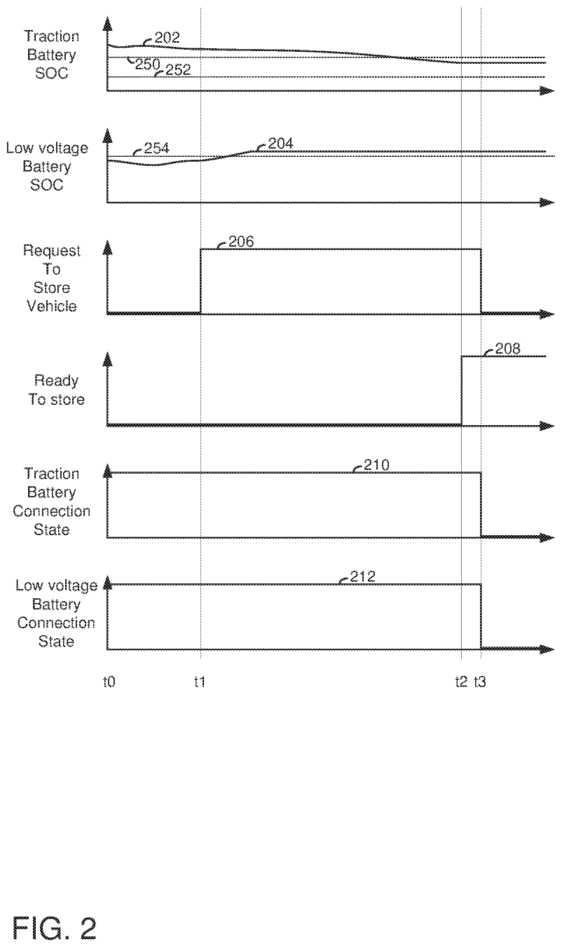

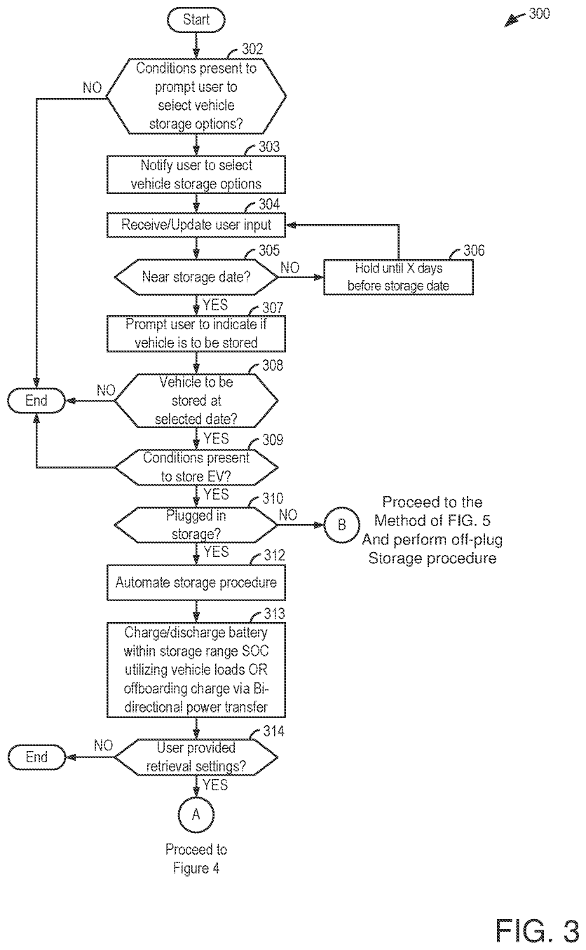

The present description is related to preparing a vehicle that includes an electric propulsion system for extended or long term storage. The methods and systems described herein may extend life cycles of batteries and charge capacities of batteries of a vehicle. The approach may prompt vehicle users to drive the vehicle on a prescribed route so that the vehicle's batteries are in a desired state when the vehicle reaches a storage area or space. In addition, the approach may exchange charge between batteries in response to a request to prepare a vehicle for extended storage so that each battery may be stored with a unique amount of charge that is suitable for the individual battery. An example electric vehicle is shown in FIG. 1 and an example sequence illustrating a process for preparing a vehicle for extended storage is shown in FIG. 2. FIGS. 3-9 show flowcharts for preparing a vehicle for extended storage. A plot of example travel routes are shown in FIG. 10.

FIG. 1 is a block diagram of an example vehicle propulsion system 100 for vehicle 121. A front portion of vehicle 121 is indicated at 110 and a rear portion of vehicle 121 is indicated at 111. Vehicle propulsion system 100 includes electric machine 126. Electric machine 126 may consume or generate electrical power depending on its operating mode. Throughout FIG. 1, mechanical connections between various components are illustrated as solid lines, whereas electrical connections between various components are illustrated as dashed lines.

Vehicle propulsion system 100 has a rear axle 122. In some examples, rear axle 122 may comprise two half shafts, for example first half shaft 122a, and second half shaft 122b. Vehicle propulsion system 100 further has front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 126a of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over controller area network (CAN) 199. Alternatively, high gear clutch 178 and low gear clutch 176 may be opened and closed via digital outputs or pulse widths provided via control system 114. Rear drive unit 136 may include differential 128 so that torque may be provided to first half shaft 122a and to second half shaft 122b. In some examples, an electrically controlled differential clutch (not shown) may be included in rear drive unit 136.

Electric machine 126 may receive electrical power from onboard electrical energy storage device (e.g. a traction battery) 132. Furthermore, electric machine 126 may provide a generator function to convert the vehicle's kinetic energy into electrical energy, where the electrical energy may be stored at electric energy storage device 132 for later use by electric machine 126. An inverter system controller 134 (ISC1) may convert alternating current generated by electric machine 126 to direct current for storage at the electric energy storage device 132 and vice versa. Electric drive system 135 includes electric machine 126 and inverter system controller 134. Electric energy storage device 132 may be a battery, capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148.

In some examples, electric energy storage device 132 may be configured to store electrical energy that may be supplied via a high voltage bus 195 (e.g., components such as conductors that carry high voltage (e.g., voltage greater than 300 volts). High voltage bus 195 may be in electrical communication with high voltage vehicle accessories (e.g., heat pump, air conditioner, heater, etc.) 186 and power converter 191 (e.g., direct current (DC) to DC converter or alternating current (AC) to DC converter). Power converter 191 is electrically coupled to electrical receptacle 190 and electrical receptacle 190 may be electrically coupled to an external stationary electric power grid 198 (e.g., a charging station) via cord 193. Receptacle sensor 197 provides an indication of whether or not vehicle 121 is plugged in to the stationary electric power grid 198. Stationary electric power grid 198 resides external to the vehicle (e.g., not part of the vehicle). High voltage bus 195 may also be electrically coupled to bidirectional DC/DC converter 184, which allows electric power to be transferred from high voltage bus 195 to low voltage bus 196. Thus, electric power may be exchanged between electric energy storage device 132 and low voltage battery 182 (e.g., battery voltage of less than 20 volts). Optional electric contactor 185 may be selectively opened to prevent power flow from low voltage battery 182 to low voltage accessories 183 (e.g., window motors, vehicle lighting, an audio system, etc.) and closed to permit power flow between low voltage battery 182 and low voltage accessories 183.

Electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 112). Power distribution module 138 controls flow of power into and out of electric energy storage device 132. A contactor 133 may selectively couple and decouple electric energy storage device 132 to high voltage bus 195 and inverter system controller (ISC1) 134. In some examples, contactor 133 may be located external to the electric energy storage device 132.

Control system 114 may communicate with electric machine 126, energy storage device 132, navigation system 187, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102, or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator (e.g., user) requested vehicle braking via a human operator 102, or an autonomous controller. For example, control system 114 may receive sensory feedback from pedal position sensor 157 which communicates with brake pedal 156.

One or more wheel speed sensors (WSS) 123 may be coupled to one or more wheels of vehicle propulsion system 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 123, etc. In some examples, sensors associated with electric machine 126, wheel speed sensor 123, etc., may communicate information to controller 112, regarding various states of electric machine operation. Controller 112 includes non-transitory (e.g., read only memory) 165, random access memory 166, digital inputs/outputs 168, and a microcontroller 167. Controller 112 may receive input data and provide data to human/machine interface 140 via CAN 199. Additionally, controller 112 may send vehicle data and receive command instructions (e.g. a request to prepare the vehicle for extended storage) via transceiver 160 and remote device 161 (e.g., cell phone, tablet, or other remote wireless device). Remote device 161 may transmit commands and receive data via cellular or satellite network 162.

The systems of FIG. 1 provides for a system, comprising: a vehicle including a traction battery; a non-traction battery; a wireless communication device; and one or more controllers including executable instructions stored in non-transitory memory that cause the one or more controllers to prepare the vehicle for extended storage in response to a request to place the vehicle in extended storage generated via the wireless communication device, where preparing the vehicle for extended storage includes requesting adjusting a level of charge stored in the traction battery. In a first example, the system includes where preparing the vehicle for extended storage also includes requesting adjusting a level of charge stored in the non-traction battery, where the level of charge stored in the non-traction battery is larger than the level of charge stored in the traction battery. In a second example that may include the first example, the system includes where preparing the vehicle for extended storage includes prompting a user to drive the vehicle to discharge the traction battery. In a third example that may include one or both of the first and second examples, the system includes where preparing the vehicle for extended storage includes prompting a user to plug the vehicle into a charging device. In a fourth example that may include one or more of the first through third examples, the system includes where preparing the vehicle for extended storage includes activating one or more ancillary electric power consumers. In a fifth example that may include one or more of the first through fourth examples, the system includes where preparing the vehicle for extended storage includes generating a travel route to a storage area. In a sixth example that may include one or more of the first through fifth examples, the system includes where preparing the vehicle for extended storage includes discharging the traction battery to a stationary electric power grid.

Referring now to FIG. 2, a sequence of a method for preparing a vehicle for extended storage is shown. The sequence shown in FIG. 2 may be provided via the system of FIG. 1 in cooperation with the method of FIGS. 3-11.

The first plot from the top of FIG. 2 is a plot of traction battery state of charge versus time. The vertical axis represents traction battery state of charge (SOC) and the SOC value increases (e.g., indicates a higher level of charge stored in the battery) in the direction of the vertical axis arrow. The horizontal axis represents time and time increases from the left side of the plot to the right side of the plot. Trace 202 represents the traction battery SOC. Horizontal line 250 represents an upper threshold limit (e.g., a value that is not to be exceeded by traction battery SOC) for traction battery SOC when preparing a traction battery for extended storage. Horizontal line 252 represents a lower threshold limit (e.g., a value that traction battery SOC is to be maintained above) for traction battery SOC when preparing a traction battery for extended storage. Trace 202 represents the traction battery SOC.

The second plot from the top of FIG. 2 is a plot of low voltage battery state of charge versus time. The vertical axis represents low voltage battery state of charge (SOC) and the low voltage battery SOC value increases (e.g., indicates a higher level of charge stored in the battery) in the direction of the vertical axis arrow. The horizontal axis represents time and time increases from the left side of the plot to the right side of the plot. Trace 204 represents the low voltage battery SOC. Horizontal line 254 represents a lower threshold limit (e.g., a value that low voltage battery SOC is to be maintained above) for low voltage battery SOC when preparing a low voltage battery for extended storage. Trace 204 represents the low voltage battery SOC.

The third plot from the top of FIG. 2 is a plot of a state of a request to store a vehicle for an extended duration (e.g., longer than three weeks) versus time. The vertical axis represents the state of the request to store the vehicle and the request to store the vehicle is asserted when trace 206 is at a level that is near the vertical axis arrow. The request to store the vehicle is not asserted when trace 206 is at a level that is near the horizontal axis. The horizontal axis represents time and time increases from the left side of the plot to the right side of the plot. Trace 206 represents the request to store the vehicle state.

The fourth plot from the top of FIG. 2 is a plot of a state of a vehicle ready to store indication versus time. The vertical axis represents the state of the vehicle ready to store indication and the vehicle ready to store indication is asserted when trace 208 is at a level that is near the vertical axis arrow. The vehicle ready to store indication is not asserted when trace 208 is at a level that is near the horizontal axis. The horizontal axis represents time and time increases from the left side of the plot to the right side of the plot. Trace 208 represents the vehicle ready to store state.

The fifth plot from the top of FIG. 2 is a plot of a state of a traction battery connection state versus time. The vertical axis represents the traction battery connection state and the traction battery is electrically connected to electric power consumers (e.g., inverter system controller 134) when trace 210 is at a level that is near the vertical axis arrow. The traction battery is not electrically connected to electric power consumers when trace 210 is at a level that is near the horizontal axis. The horizontal axis represents time and time increases from the left side of the plot to the right side of the plot. Trace 210 represents the traction battery connection state.

The sixth plot from the top of FIG. 2 is a plot of a state of a low voltage battery connection state versus time. The vertical axis represents the low voltage battery connection state and the low voltage battery is electrically connected to electric power consumers (e.g., inverter system controller 134) when trace 212 is at a level that is near the vertical axis arrow. The low voltage battery is not electrically connected to electric power consumers when trace 212 is at a level that is near the horizontal axis. The horizontal axis represents time and time increases from the left side of the plot to the right side of the plot. Trace 212 represents the low voltage battery connection state.

At time t0, the traction battery SOC is greater than thresholds 250 and 252. The low voltage battery SOC is less than threshold 254 and the request to store the vehicle is not asserted. The vehicle is not ready to store and the traction and low voltage batteries are not disconnected from electric power consumers.

At time t1, the request to store the vehicle is asserted. The request to store the vehicle may be generated via a remote handheld device or via a human/machine interface onboard the vehicle. The vehicle is not in a state where the vehicle is ready to be stored. The traction battery SOC is above threshold 250 and the low voltage battery SOC is below threshold 254. The traction battery and the low voltage battery remain connected to the high voltage and low voltage busses. Shortly after time t1, the user or vehicle operator is supplied with a travel route (not shown) to discharge the traction battery and the user begins to follow the travel route (not shown). Additionally, charge begins to be transferred from the traction battery to the low voltage battery via a DC/DC converter. Consequently, the charge of the low voltage battery begins to increase.

At time t2, the vehicle is at the vehicle storage location (not shown) and the traction battery SOC is between threshold 250 and threshold 252. The low voltage battery SOC is above threshold 254. Therefore, the ready to store indication is asserted. The traction battery and the low voltage battery remain connected to electric power consumers. The request to store the vehicle remains asserted.

At time t3, the traction battery and the low voltage battery are disconnected from electrical loads so that charge may not be drawn from or provided to the batteries. The request to store the vehicle changes state to not asserted. The traction battery SOC and the low voltage battery SOC remain in range for storage of the batteries.

In this way, SOC levels for a traction battery and a low voltage battery may be adjusted in response to a request to store a vehicle for an extended duration. Charge may be exchanged between the traction battery and the low voltage battery so that the batteries may be stored with charge in a specified range.

Referring now to FIGS. 3-9, a flowchart of a method to store a vehicle that includes an electrically powered propulsion source is shown. Method 300 may be carried out by a control system of a vehicle that includes one or more controllers 112 to perform a vehicle storage process. The one or more controllers may include executable instructions stored in non-transitory memory to perform method 300. The method of FIG. 3 in cooperation with the system of FIG. 1 may generate the sequence of FIG. 2.

Referring now to FIG. 3, a high level flowchart of a method to store a vehicle that includes an electrically powered propulsion source is shown. Method 300 may be carried out by a control system of a vehicle that includes one or more controllers 112 to perform a vehicle storage process. The one or more controllers may include executable instructions stored in non-transitory memory to perform method 300. The method of FIG. 3 in cooperation with the system of FIG. 1 may generate the sequence of FIG. 2.

At 302, method 300 judges whether or not conditions are present to prompt a user to select vehicle storage options. Conditions may include, but are not limited to a calendar date and time range (e.g., Oct. 15, 2025), ambient weather temperature, and prior vehicle storage history (e.g., dates and times that the vehicle was in a storage mode). If method 300 judges that conditions are present to prompt the user to select vehicle storage options, the answer is yes and method 300 proceeds to 303. Otherwise, the answer is no and method 300 proceeds to exit.

At 303, method 300 notifies the user via visual and/or audible message to input vehicle storage parameters. The vehicle storage parameters may include, but are not limited to beginning and ending vehicle storage dates and times, preferred SOC levels for traction and low voltage batteries, location where the vehicle is to be stored, whether the vehicle is to be stored connected to a stationary electric power grid or disconnected from the stationary electric power grid, and preferred ways for the batteries to reach their respective SOC levels immediately before entering the extended storage mode. Method 300 prompts the vehicle user (e.g., a human) via a human/machine interface or remote wireless device to enter the vehicle storage parameters. Method 300 proceeds to 304.

At 304, method 300 receives the requested vehicle storage parameters to a vehicle controller via the human/machine interface or the remote wireless device. The vehicle storage parameters may be updated and they may include but are not limited to the intended vehicle storage dates, requested battery state of charge (SOC) at time of vehicle retrieval, and requested passenger cabin temperature at time of vehicle retrieval. Method 300 proceeds to 305.

At 305, method 300 judges whether or not the present date is near (e.g., within two days) of the requested storage date. If so, the answer is yes and method 300 proceeds to 307. Otherwise, the answer is no and method 300 proceeds to 306.

At 306, method 300 performs a hold on notifying the user that the storage date is approaching. The hold also allows the user time to change the storage date and requested vehicle storage parameters. Method 300 returns to 304.

At 307, method 300 prompts the user for input as to whether or not the vehicle is to be stored at the requested date. Method 300 may prompt the user via a remote device or via a human/machine interface. Method 300 proceeds to 308.

At 308, method 300 judge whether or not the vehicle is to be stored at the requested date according to the user input at 307. If method 300 judges that the vehicle is to be stored at the requested date, the answer is yes and method 300 proceeds to 309. Otherwise, the answer is no and method 300 proceeds to exit.

At 309, method 300 judges whether or not conditions are present to begin a vehicle extended storage process. The conditions may include, but are not limited to the present calendar date and time beginning within a threshold amount of time of the requested vehicle storage date. If method 300 judges that conditions are present to begin the vehicle extended storage process, the answer is yes and method 300 proceeds to 310. Otherwise, the answer is no and method 300 proceeds to exit.

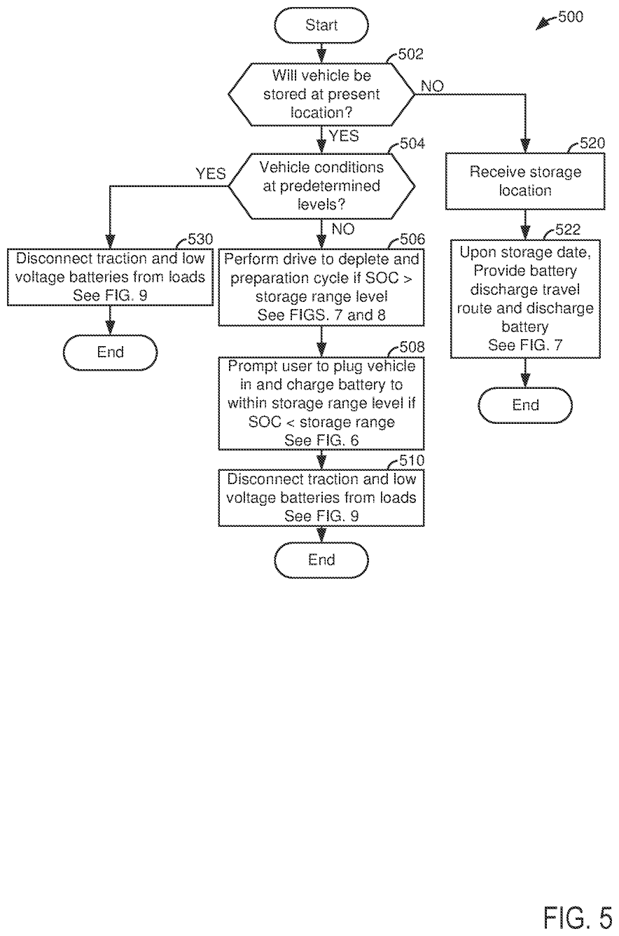

At 310, method 300 judge whether or not the vehicle is plugged in (e.g., electrically coupled) to the stationary electric power grid. Method 300 may judge whether or not the vehicle is plugged in via a receptacle sensor. If method 300 judges that the vehicle is plugged into the stationary electric power grid, the answer is yes and method 300 proceeds to 312. Otherwise, the answer is no and method 300 proceeds to FIG. 5. At FIG. 5, the off-plug storage procedure is performed.

At 312, method 300 initiates an automated storage procedure. Method 300 proceeds to 313.

At 313, method 300 charges or discharges the traction or higher voltage battery to be within a requested range SOC. The traction battery may be discharged by applying vehicle loads (e.g., propulsion sources, climate control devices, heaters, etc.) or by transferring charge from the traction battery to a stationary power grid via bi-directional power transfer. Method 300 proceeds to 314.

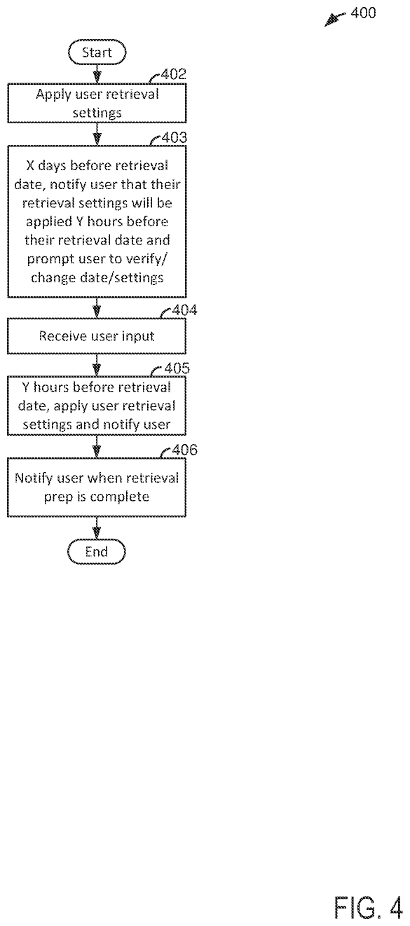

At 314, method 300 judges whether or not a user has provided retrieval setting for retrieving the vehicle. If so, the answer is yes and method 300 proceeds to the method of FIG. 4. Otherwise, the answer is no and method 300 proceeds to exit.

Thus, method 300 provides a procedure for readying a vehicle for extended storage. The procedure may include generating a travel route via a navigation system so that a vehicle user may discharge a traction battery to a requested SOC level. Once the traction battery is at the requested SOC level, the traction battery may be decoupled from an electric machine that propels the vehicle. By adjusting the traction battery SOC into the requested SOC range before storing a vehicle, degradation of charge capacity of the traction battery and the duration of life of the traction battery may be reduced.

Turning now to FIG. 4, at 402, method 400 applies the user retrieval settings that were input at 304 of FIG. 3. In particular, method 400 retrieves the settings and confirms that they are within expected ranges. Method 400 proceeds to 403.

At 403, method 400 notifies the user X (e.g., a scalar variable number) days before the vehicle retrieval date that the user retrieval setting will be applied for Y (e.g., a scalar variable number) hours before the retrieval date and prompts the user to verify and/or change the retrieval settings including the retrieval date. Method 400 may notify the user via a remote device or via a human/machine interface. Method 400 proceeds to 404.

At 404, method 400 receives user input. The user input may include revised retrieval parameters and/or a revised retrieval date. Method 400 proceeds to 405.

At 405, method 400 method 400 applies the vehicle retrieval settings and notifies the user that the settings are being applied via a human/machine interface or a remote device. Method 400 applies the retrieval settings by adjusting the traction battery SOC to the requested level, adjusting passenger cabin temperature, and adjusting user settings (e.g., seat positions, radio settings, etc.) according to the retrieved settings. Method 400 proceeds to 406.

At 406, method 400 prompts the vehicle user (e.g., a human or autonomous driver) that the retrieval preparation is complete via a remote device or human/machine interface. Method 400 proceeds to exit.

Referring now to FIG. 5, a method for off-plug vehicle storage is shown. Method 500 may be performed via the system of FIG. 1 and in cooperation with the method of FIGS. 3, 4, and 6-9. Method 500 may be stored as executable instructions in controller memory (e.g., ROM).

At 502, method 500 judges whether or not the vehicle will be stored at the vehicle's present location. Method 500 may determine the vehicle's present location via the vehicle's navigation system. Method 500 may compare the vehicle's present geographical position to the requested vehicle storage location. If method 500 judges that the vehicle is to be stored at its present geographical position, the answer is yes and method 500 proceeds to 504. Otherwise, the answer is no and method 500 proceeds to 520.

At 504, method 500 judges whether or not vehicle conditions are at requested predetermined levels. For example, method 500 may judge if the traction battery SOC is within a requested range (e.g., between 20% and 50% SOC). Further, method 500 may judge if the low voltage battery SOC is within a requested range (e.g., between 90% and 100% SOC). Because the traction battery may be comprised of Li and the low voltage battery may be comprised of Pb, the requested SOC for the traction battery may be different from the requested SOC for the low voltage battery. If method 500 determines that vehicle conditions are at requested predetermined levels, the answer is yes and method 500 proceeds to 530. Otherwise, the answer is no and method 500 proceeds to 506.

At 530, method 500 disconnects the traction battery from electrical loads via a contactor. Method 500 may also prompt a user to manually disconnect the low voltage battery from electrical loads. These actions put the vehicle in a storage mode. Method 500 proceeds to exit.

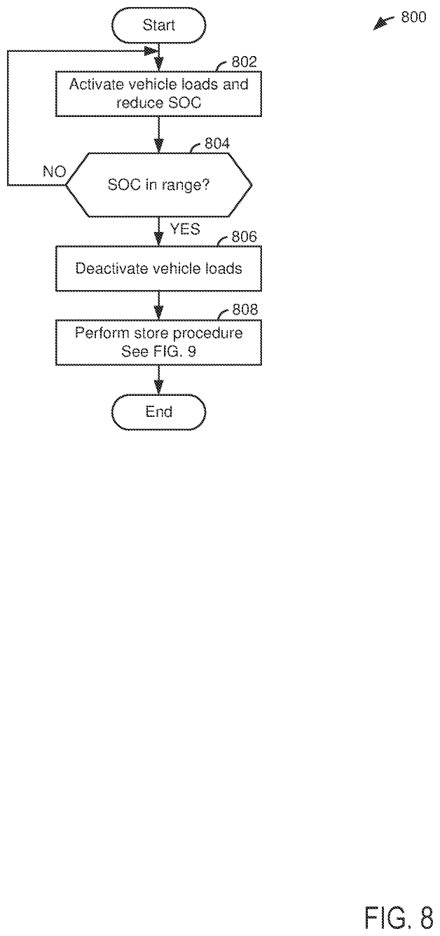

At 506, method 500 performs a drive to deplete charge cycle as shown in FIG. 7 and a preparation cycle as shown in FIG. 8 if the traction battery SOC is greater than a SOC in a predetermined range (e.g., 20% to 50% of SOC capacity of the traction battery). Method 500 proceeds to 508.

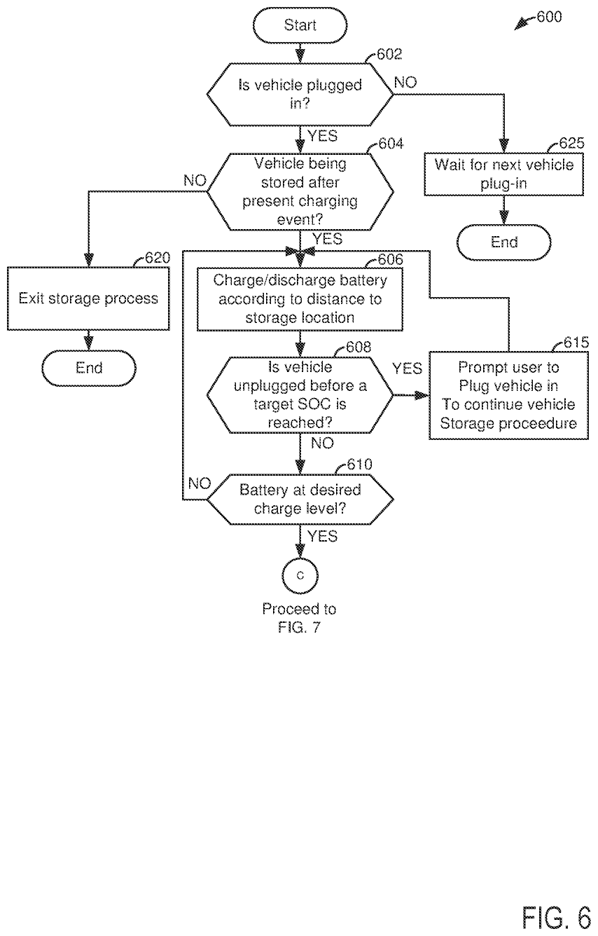

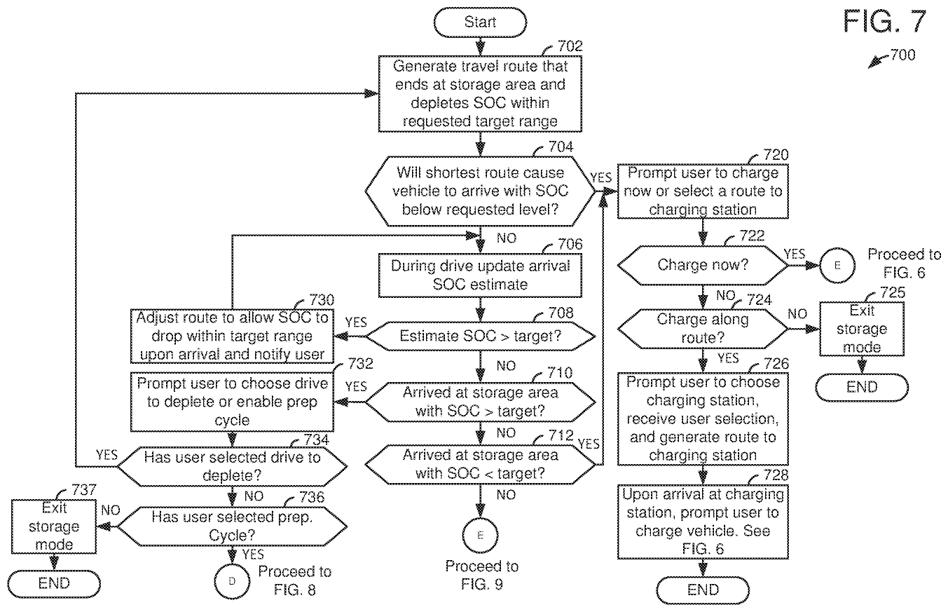

At 508, method 500 prompts the user to plug the vehicle into the stationary electric power grid as shown in FIG. 6 to charge the traction battery when the traction battery SOC is less than SOC in a predetermined range a predetermined range (e.g., 20% to 50% of SOC capacity of the traction battery). Method 500 proceeds to 510.

At 510, method 500 disconnects the traction battery from electric power consumers via opening a contactor. Method 500 may also disconnect a low voltage battery from electric power consumers via opening a contactor. If a contactor is not provided for the low voltage battery, the user may be prompted to disconnect the low voltage battery from electrical loads via a mess age to a human/machine interface or a remote wireless device. Method 500 proceeds to exit.

At 520, method 500 receives a vehicle storage location. Method 500 proceeds to 522.

At 522, method 500 provides a battery discharge route and discharges the traction battery upon the present date reaching the selected vehicle storage date as shown in FIG. 7. Method 500 proceeds to exit.

Thus, a particular sequence for preparing a vehicle for extended storage is provided when the vehicle is to be stored off-plug (e.g., not plugged into the stationary electric power grid). The off-plug sequence provides directions to a user to discharge the traction battery in a way that allows the traction battery SOC to enter a requested range that is suitable for storing the traction battery.

Referring now to FIG. 6, a method for charging a vehicle that is to be stored for an extended period of time is shown. Method 600 may be performed via the system of FIG. 1 and in cooperation with the methods of FIGS. 3-5 and 7-9. Method 600 may be stored as executable instructions in controller memory (e.g., ROM).

At 602, method 600 judges whether or not the vehicle is plugged in to the stationary electric power grid. Method 600 may judge whether or not the vehicle is plugged in via a receptacle sensor. If method 600 judges that the vehicle is plugged into the stationary electric power grid, the answer is yes and method 600 proceeds to 604. Otherwise, the answer is no and method 600 proceeds to 625.

At 625, method 600 prompts the user to plug the vehicle in to the stationary electric power grid. The user may be prompted via sending a message to the human/machine interface or the remote wireless device. Method 600 waits for the user to plug the vehicle in to the stationary electric power grid. Method 600 exits.

At 604, method 600 judges whether or not the vehicle is being stored at the vehicle's present geographical location after the vehicle is plugged in to the stationary electric power grid. Method 600 may compare the vehicle's present geographical position with the vehicle storage location that has been input to the vehicle by the user. Additionally, method 600 may compare the present date to the beginning storage date. If method 600 judges that the vehicle is presently at the vehicle storage location and the present date is equal to the beginning storage date, the answer is yes and method 600 proceeds to 606. Otherwise, the answer is no and method 600 proceeds to 620.

At 620, method 600 exits the storage process. Alternatively, method 600 may prompt the user to drive the vehicle to the storage location. Method 600 proceeds to exit.

At 606, method 600 begins to charge the traction battery and/or the low voltage battery. If the traction battery SOC is not within a predetermined range, charge may be supplied to the traction battery via the stationary electric power grid. If the low voltage battery SOC is not within a predetermined range, the predetermined range of the low voltage battery SOC different than the predetermined range for the traction battery SOC, charge may be delivered to the low voltage battery via the traction battery and the DC/DC converter. Charge is delivered to the traction battery and the low voltage battery until the batteries are within their respective requested SOC ranges. Method 600 proceeds to 608.

At 608, method 600 judges whether or not the vehicle is unplugged from the stationary electric power grid before a target SOC is reached. Method 600 may judge whether or not the vehicle has become unplugged in via a receptacle sensor. If method 600 judges that the vehicle is unplugged from the stationary electric power grid before the target SOC is reached, the answer is yes and method 600 proceeds to 615. Otherwise, the answer is no and method 600 proceeds to 610.

At 615, method 600 prompts the user to plug the vehicle in to the stationary electric power grid. The user may be prompted via sending a message to the human/machine interface or the remote wireless device. Method 600 waits for the user to plug the vehicle in to the stationary electric power grid. Method 600 returns to 606 after the vehicle is plugged in to the stationary electric power grid.

At 610, method 600 judges whether the traction battery SOC is within a requested range for traction battery storage (e.g., 20%-50% of SOC charge capacity). If so, the answer is yes and method 600 proceeds to the method of FIG. 7. If not, the answer is no and method 600 returns to 606. Additionally, method 600 judges whether the traction battery SOC is within a requested range for traction battery storage (e.g., 20%-50% of SOC charge capacity). If so, the answer is yes and method 600 proceeds to the method of FIG. 10. If not, the answer is no and method 600 returns to 606.

Moving on to FIG. 7, a method for providing a travel route for discharging the traction battery is shown. Method 700 may be performed via the system of FIG. 1 and in cooperation with the methods of FIGS. 3-6 and 8-9. Method 700 may be stored as executable instructions in controller memory (e.g., ROM).

At 702, method 700 generates a travel route for the vehicle that ends at the vehicle storage area and that depletes the traction battery so that the traction battery SOC is within a requested range (e.g., between 20% and 50% of SOC capacity, where the SOC capacity is 100%). The vehicle's present geographical location and the vehicle storage location are input to the navigation system and the navigation system outputs a route that is expected to consume charge from the traction battery so that the traction battery SOC is within a requested range for storing the traction battery. Method 700 may estimate an amount of charge that is consumed to drive the vehicle a predetermined distance (e.g., 10 kilometers) according to known vehicle energy consumption data or models. The travel route may be broken into a plurality of segments and the energy consumption for each of the segments may be added together to provide an estimate of the total amount of charge that is expected to be consumed when the vehicle travels from its present geographical location to the vehicle storage geographical location. For example, if it is determined that a first travel route to the vehicle storage geographical location takes an amount of charge that is equal to 5% of the traction battery's SOC level, and that a second travel route to the vehicle storage geographical location takes an amount of charge that is equal to 10% of the traction battery's SOC level, when the traction battery SOC is 60%, then method 700 may select the second travel route so that the vehicle arrives with traction battery SOC in the requested range (e.g., between 20% and 50%). Method 700 displays the travel route via the human/machine interface. Method 700 proceeds to 704.

At 704, method 700 judges whether or not the shortest generated vehicle travel route will cause the vehicle to arrive at the storage area with SOC below a requested level. If so, the answer is yes and method 700 proceeds to 720. If not, the answer is no and method 700 proceeds to 706.

At 720 method 700 prompts the user via a human/machine interface to charge the vehicle now or to select a travel route to a charging station. Method 700 proceeds to 722.

At 722, method 700 judges if the user has chosen to charge the traction battery now. If so, the answer is yes and method 700 proceeds to the method of FIG. 6. If not, method 700 proceeds to 724.

At 724, method 700 judges whether or not the user has selected to charge the traction battery along the vehicle travel route. If so, the answer is yes and method 700 proceeds to 726. If not, the answer is no and method 700 proceeds to 725.

At 725, method 700 exits the vehicle storage mode and then exits. Exiting the vehicle storage mode may include erasing the vehicle travel route and removing user prompts.

At 726, method 700 prompts the user to select or choose a traction battery charging station, receive a user selection of the charging station, and generate a route to the charging station via a vehicle navigation system. Method 700 proceeds to 728.

At 728, method 700 prompts the user to charge the traction battery upon the vehicle reaching the charging destination. Method 700 may proceed to the method of FIG. 6 and then exit.

At 706, method 700 periodically updates the arrival SOC estimate for the vehicle. That is, method 700 may revise the SOC level that the vehicle is predicted to have when it reaches the vehicle storage area. Method 700 proceeds to 708.

At 708, method 700 judges whether or not the SOC estimate for when the vehicle reaches its storage destination is greater than a target SOC. If method 700 judges that the SOC estimate is greater than the target SOC, the answer is yes and method 700 proceeds to 730. Otherwise, the answer is no and method 700 proceeds to 710.

At 710, method 700 judges whether or not the vehicle has arrived at the vehicle storage area with SOC greater than a target SOC. If method 700 judges that the SOC is greater than the target SOC, the answer is yes and method 700 proceeds to 732. Otherwise, the answer is no and method 700 proceeds to 712.

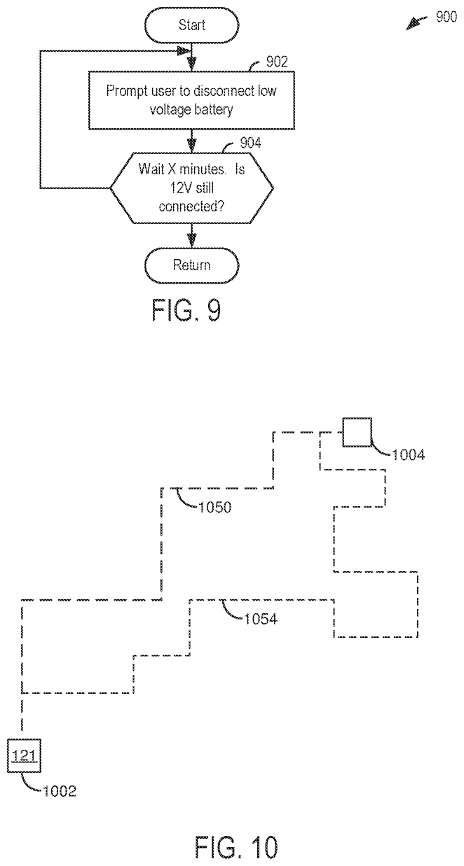

At 712, method 700 judges whether or not the vehicle has arrived at the vehicle storage area with SOC less than a target SOC. If method 700 judges that the SOC is less than the target SOC, the answer is yes and method 700 proceeds to 720. Otherwise, the answer is no and method 700 proceeds to the method of FIG. 9.

At 730, method 700 adjust the vehicle travel route to allow additional traction battery charge to be consumed so that the traction battery SOC is within the target SOC range. Thus, method 700 may increase the distance of the travel route. Method 700 returns to 706.

At 732, method 700 prompts the user via the human/machine interface to choose and select drive to deplete SOC or enable vehicle preparation cycle. Method 700 proceeds to 734.

At 734, method 700 judges if the user has selected to drive the vehicle until the SOC is depleted into a requested SOC range. If so, the answer is yes and method 700 returns to 702. If not, the answer is no and method 700 proceeds to 736.

At 736, method 700 judges whether or not the user has selected a preparation cycle. If so, the answer is yes and method 700 proceeds to the method of FIG. 8. If not, the answer is no and method 700 exits the storage mode.

Referring now to FIG. 8, a method for depleting charge in a traction battery is shown. Method 800 may be performed via the system of FIG. 1 and in cooperation with the methods of FIGS. 3-7 and 9. Method 800 may be stored as executable instructions in controller memory (e.g., ROM).

At 802, method 800 activates electrical loads to reduce traction battery SOC. Method 800 may activate a heat pump, heater, or air conditioner to reduce traction battery SOC since these devices may be electrically coupled to the same high voltage bus that the traction battery is coupled to. In addition, method 800 may reduce charge in the traction battery via activating low voltage loads such as windscreen heaters, pumps, motors, audio systems, etc. These low voltage devices may consume charge that is transferred from the high voltage bus to the low voltage bus via the DC/DC converter. Method 800 proceeds to 804 after the electrical loads or power consumers are activated.

At 804, method 800 judges whether or not the traction battery SOC is within a requested range for extended traction battery storage (e.g., 20%-50% SOC). If so, the answer is yes and method 800 proceeds to 806. Otherwise, the answer is no and method 800 returns to 802.

At 806, method 800 deactivates the electrical loads or consumers that were activated at 804. Method 800 proceeds to 808.

At 808, method 800 performs the vehicle storage procedure or method of FIG. 9. Method 800 proceeds to exit after the method of FIG. 9 is performed.

Thus, method 800 reduces traction battery SOC via activating electrical loads of the vehicle that do not propel the vehicle. Thus, the traction battery SOC may be reduced while the vehicle is stationary or moving.

Referring now to FIG. 9, a method for completing vehicle storage is shown. Method 900 may be performed via the system of FIG. 1 and in cooperation with the methods of FIGS. 3-8. Method 900 may be stored as executable instructions in controller memory (e.g., ROM).

At 902, method 900 decouples the traction battery from the high voltage bus and electric power consumers. Method 900 may prompt the user to disconnect the low voltage battery and the higher voltage battery may disconnect automatically via a contactor in response to the lower voltage battery being disconnected. By decoupling the traction battery and the low voltage battery, external loads may not be applied to the batteries so that charge in the batteries may be stored for a longer amount of time. Method 900 proceeds to 904.

At 904, method 900 waits X (scalar variable) minutes and then judges whether or not the 12 volt battery has been disconnected from electric power consumers. If so, the answer is yes and method 900 proceeds to return back to the calling method (e.g., method 700 or method 800). Otherwise, the answer is no and method 900 returns to 902.

Thus, the methods of FIGS. 3-9 provide for a method for preparing a vehicle for storage, comprising: via a controller, preparing a traction battery for extended storage via a first procedure when the vehicle is not electrically coupled to a charging source, the charging source external to the vehicle; and via the controller, preparing the traction battery for extended storage via a second procedure when the vehicle is electrically coupled to the charging source. In a first example, the method further comprises identifying a time when the vehicle is to be placed in extended storage. In a second example that may include the first example, the method includes wherein preparing the traction battery includes reducing an amount of charge stored in the traction battery. In a third example that may include one or both of the first and second examples, the method includes wherein preparing the traction battery includes increasing an amount of charge stored in the traction battery. In a fourth example that may include one or more of the first through third examples, the method includes where preparing the traction battery for extended storage via the second procedure includes increasing or decreasing charge stored in the traction battery via a charging station. In a fifth example that may include one or more of the first through forth examples, the method includes where preparing the traction battery for extended storage via the first procedure includes decreasing charge stored in the traction battery via providing a travel route to discharge the traction battery. In a sixth example that may include one or more of the first through fifth examples, the method includes where preparing the traction battery for extended storage via the first procedure includes decreasing charge stored in the traction battery via charging a low voltage battery or operating vehicle accessories. In a seventh example that may include one or more of the first through sixth examples, the method includes where the vehicle accessories include a heat pump.

The methods of FIGS. 3-9 also provide for a method for preparing a vehicle for storage, comprising: via a controller, adjusting a state of charge of a traction battery to a first level in response to a request to store the vehicle for an extended period of time; and adjusting a state of charge of a non-traction battery to a second level in response to the request to store the vehicle for the extended period of time. In a first example, the method includes where the non-traction battery is a low voltage battery with a voltage output of less than 20 volts and the traction battery is a battery with a voltage output greater than 400 volts. In a second example that may include the first example, the method includes where the first level is between 20 and 50 percent of a maximum charge storage amount for the traction battery. In a third example that may include one or both of the first and second examples, the method includes where the second level is greater than 80 percent of a maximum charge storage amount for the non-traction battery. In a fourth example that may include one or more of the first through third examples, the method further comprises generating the request to store the vehicle for the extended period of time via a device that is remote from the vehicle.

Referring now to FIG. 10, example travel routes that may be displayed for a user to follow when driving a vehicle to deplete charge in a traction battery are shown. Vehicle 121 is shown at geographical location 1002. Two travel routes 1050 and 1054 that have been generated to help a user drain charge from the traction battery so that the traction battery SOC is within a requested range are shown. The vehicle extended storage geographical location is indicated at 1004. The travel route 1050 is shorter in length than travel route 1054 so travel route 1050 may be selected when less charge is to be drained from the traction battery. However, road grade and road conditions may also factor into the amount of charge that is drawn from the traction battery when a particular travel route is selected and driven. Travel route 1054 may be selected and driven when a greater amount of charge is requested to be drawn from the traction battery. The travel routes may be generated via the vehicle's navigation system.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, single cylinder, I3, I4, I5, V6, V8, V10, and V12 engines operating in natural gas, gasoline, diesel, or alternative fuel configurations could use the present description to advantage.

1. A method for preparing a vehicle for storage, comprising:
via a controller, preparing a traction battery for extended storage via a first procedure when the vehicle is not electrically coupled to a charging source, the charging source external to the vehicle; and
via the controller, preparing the traction battery for extended storage via a second procedure when the vehicle is electrically coupled to the charging source.

2. The method of claim 1, further comprising identifying a time when the vehicle is to be placed in extended storage.

3. The method of claim 1, wherein preparing the traction battery includes reducing an amount of charge stored in the traction battery.

4. The method of claim 1, wherein preparing the traction battery includes increasing an amount of charge stored in the traction battery.

5. The method of claim 1, where preparing the traction battery for extended storage via the second procedure includes increasing or decreasing charge stored in the traction battery via a charging station.

6. The method of claim 1, where preparing the traction battery for extended storage via the first procedure includes decreasing charge stored in the traction battery via providing a travel route to discharge the traction battery.

7. The method of claim 1, where preparing the traction battery for extended storage via the first procedure includes decreasing charge stored in the traction battery via charging a low voltage battery or operating vehicle accessories.

8. The method of claim 7, where the vehicle accessories include a heat pump.

9. A system, comprising:
a vehicle including a traction battery;
a non-traction battery;
a wireless communication device; and
one or more controllers including executable instructions stored in non-transitory memory that cause the one or more controllers to prepare the vehicle for extended storage in response to a request to place the vehicle in extended storage generated via the wireless communication device, where preparing the vehicle for extended storage includes requesting adjusting a level of charge stored in the traction battery.

10. The system of claim 9, where preparing the vehicle for extended storage also includes requesting adjusting a level of charge stored in the non-traction battery, where the level of charge stored in the non-traction battery is larger than the level of charge stored in the traction battery.

11. The system of claim 9, where preparing the vehicle for extended storage includes prompting a user to drive the vehicle to discharge the traction battery.

12. The system of claim 9, where preparing the vehicle for extended storage includes prompting a user to plug the vehicle into a charging device.

13. The system of claim 9, where preparing the vehicle for extended storage includes activating one or more ancillary electric power consumers.

14. The system of claim 9, where preparing the vehicle for extended storage includes generating a travel route to a storage area.

15. The system of claim 9, where preparing the vehicle for extended storage includes discharging the traction battery to a stationary electric power grid.

16. A method for preparing a vehicle for storage, comprising:
via a controller, adjusting a state of charge of a traction battery to a first level in response to a request to store the vehicle for an extended period of time; and
adjusting a state of charge of a non-traction battery to a second level in response to the request to store the vehicle for the extended period of time.

17. The method of claim 16, where the non-traction battery is a low voltage battery with a voltage output of less than 20 volts and the traction battery is a battery with a voltage output greater than 400 volts.

18. The method of claim 16, where the first level is between 20 and 50 percent of a maximum charge storage amount for the traction battery.

19. The method of claim 18, where the second level is greater than 80 percent of a maximum charge storage amount for the non-traction battery.

20. The method of claim 16, further comprising generating the request to store the vehicle for the extended period of time via a device that is remote from the vehicle.
